(19) United States
(12) Patent Application Publication
(10) Pub. No.: US 2020/0226650 A1
(43) Pub. Date: Jul. 16, 2020

(54) ENERGY MANAGEMENT SYSTEM WITH AIRFLOW BASED TENANT ENERGY USAGE DETERMINATIONS

(71) Applicant: Johnson Controls Technology Company, Auburn Hills, MI (US)

(72) Inventors: Barkha Shah, Mumbai (IN); Rajesh Nayak, Vidyaratna Nagar Manipal (IN); Lawrence Dsouza, East Mumbai (IN); Mukul Vashisth, Pune (IN)

(73) Assignee: Johnson Controls Technology Company, Auburn Hills, MI (US)

(21) Appl. No.: 16/274,699

(22) Filed: Feb. 13, 2019

(30) Foreign Application Priority Data
Jan. 14, 2019 (IN) 201921001566

(51) Int. Cl. G06Q 30/04; G06Q 30/02; G06Q 50/06; F24F 11/30; F24F 11/63; G01D 4/00

(52) U.S. Cl. CPC G06Q 30/04; G06Q 30/0283; G06Q 50/06; F24F 2140/60; F24F 11/63; G01D 4/002; F24F 11/30

(57) ABSTRACT

A building system of a building includes one or more memory devices configured to store instructions that, when executed by one or more processors, cause the one or more processors to receive meter data from a meter of the building, the meter data indicating energy usage of a plurality of tenants of the building collectively. The instructions cause the one or more processors to receive variable air volume (VAV) airflow data of a plurality of VAV units indicating environmental conditioning of a plurality of tenant areas associated with the plurality of tenants and determine the energy usage of each of the plurality of tenants individually based on the meter data and the VAV airflow data.

### CROSS-REFERENCE TO RELATED PATENT APPLICATION

This application claims the benefit of and priority to Indian Provisional Patent Application No. 201921001566 filed Jan. 14, 2019, the entirety of which is incorporated by reference herein.

### BACKGROUND

The present disclosure relates generally to heating, ventilation, and air conditioning (HVAC) systems of buildings. The present disclosure relates more particularly to an energy management system for operating, controlling, and/or analyzing data of the HVAC systems.

Some buildings are designed for multiple different tenants which may rent certain areas of the building. For example, commercial buildings may include zones, rooms, or other areas structured for multiple different companies to exist within a single building. Furthermore, buildings such as apartment buildings may include multiple different housing units where one or multiple different tenants live. These tenants may have lease agreements with the owner of the building and may make payments for their electricity usage within the building. However, many buildings only include a single building meter (or a single group of building meters) and thus the owner of the building may only understand the energy usage of the tenants collectively, not individually. This may complicate billing making it difficult for the building owner to appropriately bill each of the tenants for their energy usage.

### SUMMARY

Another implementation of the present disclosure is a building system of a building. The building system including one or more memory devices configured to store instructions that, when executed by one or more processors, cause the one or more processors to receive meter data from a meter of the building, the meter data indicating energy usage of tenants of the building collectively, receive variable air volume (VAV) airflow data of VAV units indicating environmental conditioning of tenant areas associated with the tenants, and determine the energy usage of each of the tenants individually based on the meter data and the VAV airflow data.

In some embodiments, the instructions cause the one or more processors to generate an energy bill for each of the tenants based on the energy usage of each of the tenants and cause a user interface to display the energy bill of at least one of the tenants.

In some embodiments, the instructions cause the one or more processors to determine the energy usage of each of the tenants individually based on the meter data and the VAV airflow data by determining, for each of the tenants, one or more of the VAV units mapped to the tenant based on a building model, and determining the energy usage for each of the tenants on the meter data and the VAV airflow data of the one or more of the VAV units mapped to the tenant.

In some embodiments, the building model includes relationships mapping the tenants with the tenant areas, wherein the building model further includes relationships mapping the VAV units with the tenant areas.

In some embodiments, determining, for each of the tenants, the one or more of the VAV units mapped to the tenant based on the building model includes identifying, based on the building model, the one or more VAV units mapped to one of the tenant areas that the tenant is mapped to.

In some embodiments, the instructions cause the one or more processors to receive air handler unit (AHU) airflow data, the AHU airflow data further indicating the conditioning of the tenant areas, determine an energy usage percentage for each of the tenants based on the AHU airflow data and the VAV airflow data, and determine the energy usage of each of the tenants individually based on the meter data and the energy usage percentage for each of the tenants.

In some embodiments, the instructions cause the one or more processors to determine the energy usage percentage for each of the tenants based on the AHU airflow data and the VAV airflow data by determining an average VAV airflow amount of the tenant based on the VAV airflow data, determining an average AHU airflow amount based on the AHU airflow data, and dividing the average VAV airflow amount of the tenant by the average AHU airflow amount to determine the energy usage percentage of the tenant.

In some embodiments, the average VAV airflow amount of the tenant is a daily average VAV airflow amount, the average AHU airflow amount is a daily average AHU airflow amount, and the energy usage percentage of the tenant is a daily energy usage percentage.

In some embodiments, the instructions cause the one or more processors to determine the daily average VAV airflow amount of each of the tenant for each of days, determine the daily average AHU airflow amount for each of the days, and determine the daily energy usage percentage of each of the tenants for each of the days based on the daily average VAV airflow amount for each of the days and the daily average AHU airflow amount for each of the days.

In some embodiments, the instructions cause the one or more processors to determine a metered energy amount based on the meter data across the days, average the daily energy usage percentage of each of the tenants across the days, and determine the energy usage amount of each of the tenant based on the metered energy amount across the days and the daily energy usage percentage of each of the tenants averaged across the days.

In some embodiments, the days are days of a billing cycle associated with the tenants.

Another implementation of the present disclosure is a building system of a building. The building system includes an air handler unit (AHU) configured to supply air to variable air volume (VAV) units and the VAV units configured to supply the air of the AHU to tenant areas. The system includes one or more memory devices configured to store instructions that, when executed by one or more processors, cause the one or more processors to receive meter data from a meter of the building, the meter data indicating energy usage of tenants of the building collectively, receive VAV airflow data of the VAV units indicating environmental conditioning of tenant areas associated with the tenants, and determine the energy usage of each of the tenants individually based on the meter data and the VAV airflow data.

In some embodiments, the instructions cause the one or more processors to generate an energy bill for each of the tenants based on the energy usage of each of the tenants and cause a user interface to display the energy bill of at least one of the tenants.

In some embodiments, the instructions cause the one or more processors to determine the energy usage of each of the tenants individually based on the meter data and the VAV airflow data by determining, for each of the tenants, one or more of the VAV units mapped to the tenant based on a building model and determining the energy usage for each of the tenants on the meter data and the VAV airflow data of the one or more of the VAV units mapped to the tenant.

In some embodiments, the instructions cause the one or more processors to receive AHU airflow data, the AHU airflow data further indicating the conditioning of the tenant areas, determine an energy usage percentage for each of the tenants based on the AHU airflow data and the VAV airflow data, and determine the energy usage of each of the tenants individually based on the meter data and the energy usage percentage for each of the tenants.

In some embodiments, the instructions cause the one or more processors to determine the energy usage percentage for each of the tenants based on the AHU airflow data and the VAV airflow data by determining an average VAV airflow amount of the tenant based on the VAV airflow data, determining an average AHU airflow amount based on the AHU airflow data, and dividing the average VAV airflow amount of the tenant by the average AHU airflow amount to determine the energy usage percentage of the tenant.

In some embodiments, the average VAV airflow amount of the tenant is a daily average VAV airflow amount, the average AHU airflow amount is a daily average AHU airflow amount, and the energy usage percentage of the tenant is a daily energy usage percentage.

In some embodiments, the instructions cause the one or more processors to determine the daily average VAV airflow amount of each of the tenants for each of the days, determine the daily average AHU airflow amount for each of the days, and determine the daily energy usage percentage of each of the tenants for each of the days based on the daily average VAV airflow amount for each of the days and the daily average AHU airflow amount for each of the days.

In some embodiments, the instructions cause the one or more processors to determine a metered energy amount based on the meter data across the days, average the daily energy usage percentage of each of the tenants across the days, and determine the energy usage amount of each of the tenants based on the metered energy amount across the days and the daily energy usage percentage of the each of the tenants averaged across the days.

Another implementation of the present disclosure is a method of a building system. The method includes receiving, by a processing circuit, meter data from a meter of the building, the meter data indicating energy usage of a tenants of the building collectively, receiving, by the processing circuit, variable air volume (VAV) airflow data of a VAV units indicating environmental conditioning of a tenant areas associated with the tenants, receiving, by the processing circuit, air handler unit (AHU) airflow data of an AHU further indicating environmental conditioning of the tenant areas associated with the tenants, and determining, by the processing circuit, the energy usage of each of the tenants individually based on the meter data, the VAV airflow data, and the AHU airflow data.

In some embodiments, the method includes operating the VAV units and an AHU airflow unit based on a preferred tenant energy consumption level and the energy usage of each of the tenants. In some embodiments, operating the VAV units and the AHU unit includes causing the VAV units and/or the AHU unit to consume less energy, e.g., less energy than a preferred tenant energy consumption level.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic drawing of a building equipped with a HVAC system, according to an exemplary embodiment.

FIG. 2 is a schematic block diagram of a waterside system that may be used in conjunction with the building of FIG. 1, according to an exemplary embodiment.

FIG. 3 is a schematic block diagram of an airside system that may be used in conjunction with the building of FIG. 1, according to an exemplary embodiment.

FIG. 4 is a schematic block diagram of a BMS which can be used in the building of FIG. 1, according to some embodiments.

FIG. 5 is a block diagram of the building of FIG. 1 including a single building meter, a meter analysis system, and multiple zones each rented by tenants, according to an exemplary embodiment.

FIG. 6 is a block diagram of the meter analysis system determining energy usage from the multiple zones based on the single building meter and airflow data of VAVs and AHUs of the building of FIG. 5, according to an exemplary embodiment.

FIGS. 7A-7B are a flow diagram of a process for determining tenant energy usage for a single building meter based on airflow data of the VAVs and the AHUs that can be performed by the meter analysis system of FIG. 6, according to an exemplary embodiment.

FIG. 8 is a flow diagram of a process for operating a user interface to map an energy meter to a component tree of the user interface, according to an exemplary embodiment.

FIG. 9 is a schematic drawing of the user interface of FIG. 8 that the meter analysis system of FIG. 6 can generate and manage, according to an exemplary embodiment.

### DETAILED DESCRIPTION

### Overview

Referring generally to the FIGURES, a building energy management system for dynamically allocating meter usage shares of energy usage recorded for a common meter for multiple tenants based on airflow data is shown, according to various exemplary embodiments. The building energy management system may be or may include a tenant billing system configured to capture tenant energy utilization data directly from corresponding building meters using a building management system (BMS) and be configured to generate energy bills for the tenants automatically based on the charges defined, in some embodiments. In many cases, buildings do not have a dedicated meter for each tenant because there are assets which are shared between multiple tenants occupying the same space or different spaces. Furthermore, many building owners do not want to invest in additional building meters to measure consumption for each tenant. Rather than requiring multiple different building meters, the system described herein utilizes airflow data of the multiple tenants to appropriately identify energy usage of each of the tenants individually based on energy usage measurements of a single building meter.

In some embodiments, a building owner can manually input meter percentage share values (e.g., static values indicating how energy consumption should be split) based on tenant occupied areas to appropriately divide the energy usage of multiple tenants of a building where there is only a single building meter. The percentage shares may not change unless the building owner changes it if the area occupied has changed. Furthermore, the meter percentage based on occupied area is based on the fact that more area means more consumption and hence more static meter sharing which is not always the case in reality. However, by taking into account the airflow of variable air volume (VAV) units and air handler units (AHUs) that are tied to the multiple tenants, the building energy management system can appropriately, and dynamically, identify the energy usage of each tenant without requiring multiple building meters to be installed or static percentage shares to be defined.

The building energy management system can rely on multiple aspects of building performance data, specifically airflow data, to check for the actual consumption. The building energy management system is configured to dynamically act on the building performance data to attribute meter share percentage dynamically between multiple tenants consuming energy through the same building meter, in some embodiments. The building energy management system is configured to generate realistic bills for tenants instead of, or in addition to, relying on static area data to account for meter share scenario, in some embodiments. Furthermore, the building energy management system helps to save customers spend on additional metering infrastructure cost, e.g., installing additional building meters, thereby helping a building owner to lower lease rates.

### Building Management System and HVAC System

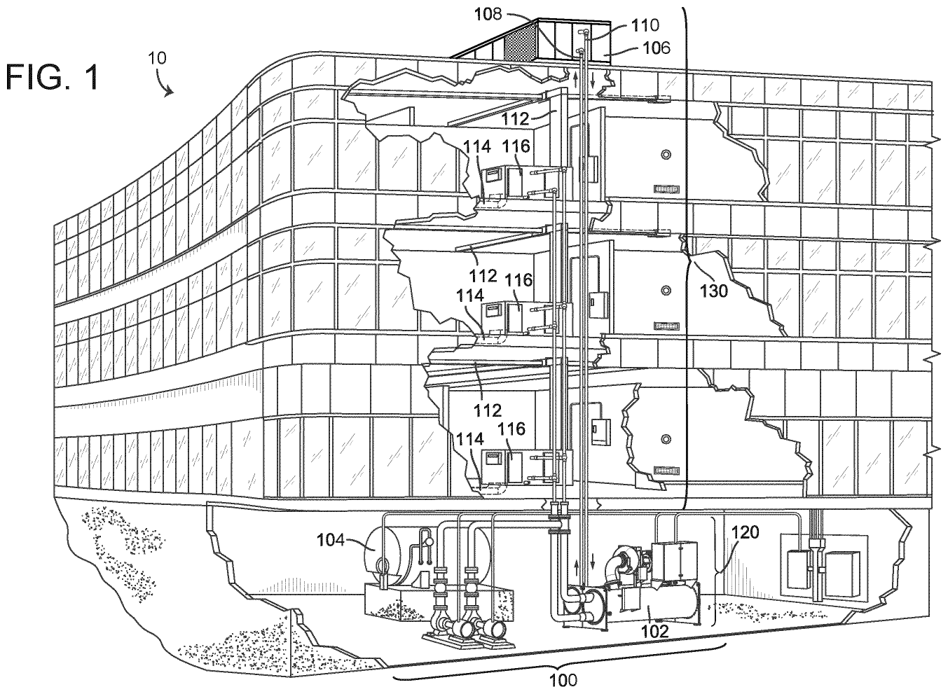

Referring now to FIGS. 1-3, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

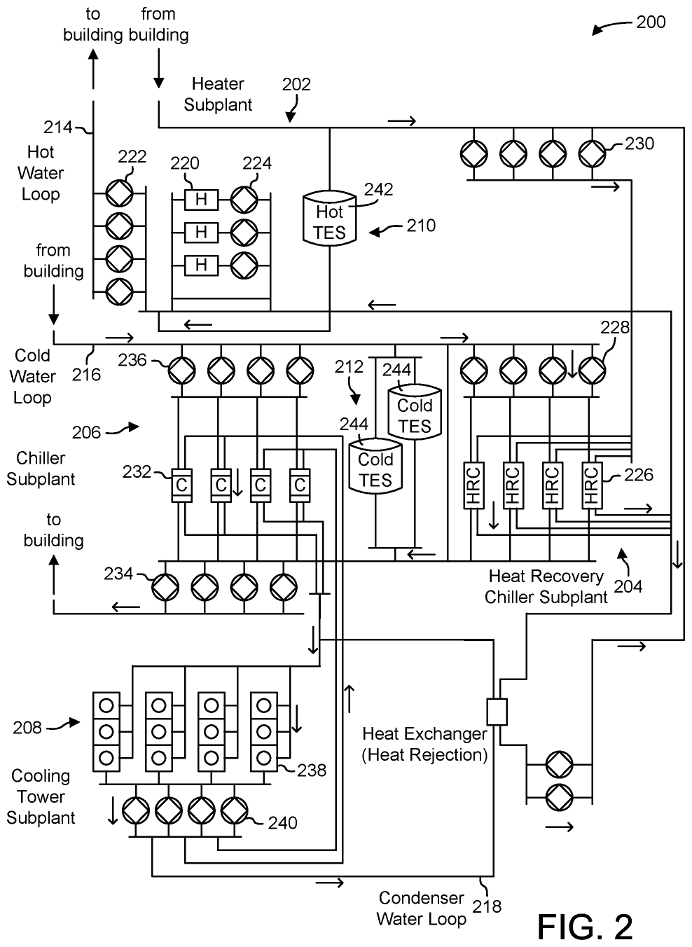

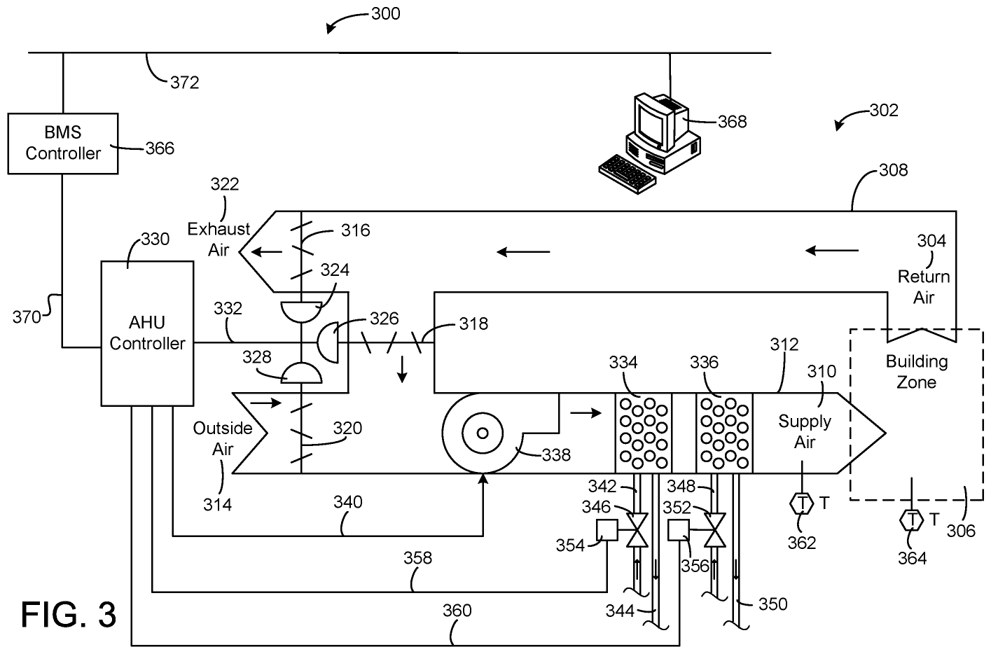

The BMS that serves building 10 includes an HVAC system 100. HVAC system 100 can include HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve set-point conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust air damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a set-point temperature for supply air 310 or to maintain the temperature of supply air 310 within a set-point temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, set-points, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

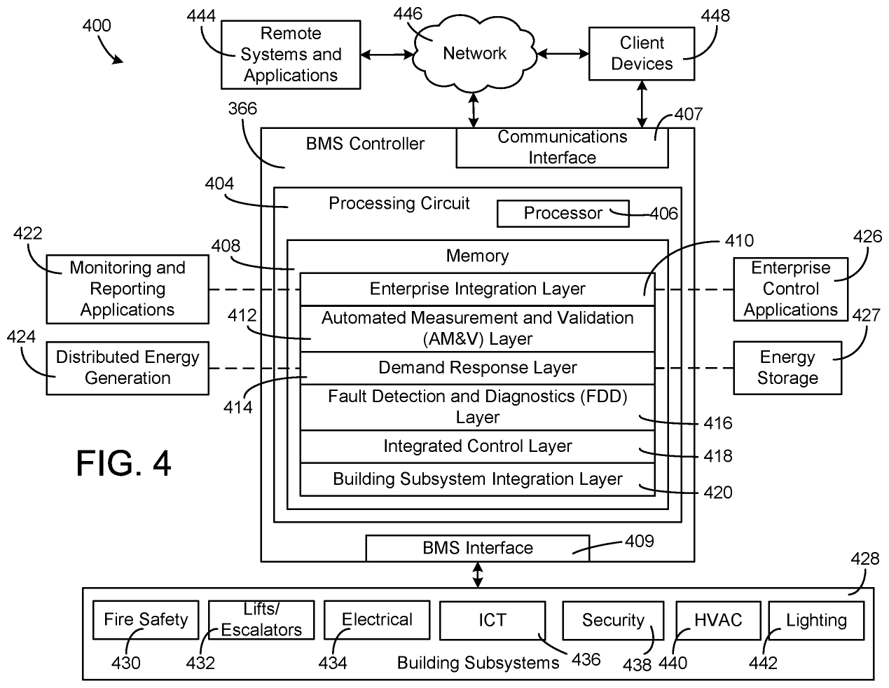

Referring now to FIG. 4, a block diagram of a building management system (BMS) 400 is shown, according to an example embodiment. BMS 400 can be implemented in building 10 to automatically monitor and control various building functions. BMS 400 is shown to include BMS controller 366 and building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an example embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an example embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an example embodiment, integrated control layer 418 includes control logic that uses inputs and outputs from building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other example embodiments, FDD layer 416 is configured to provide “fault” events to integrated control layer 418 which executes control strategies and policies in response to the received fault events. According to an example embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Energy Management System

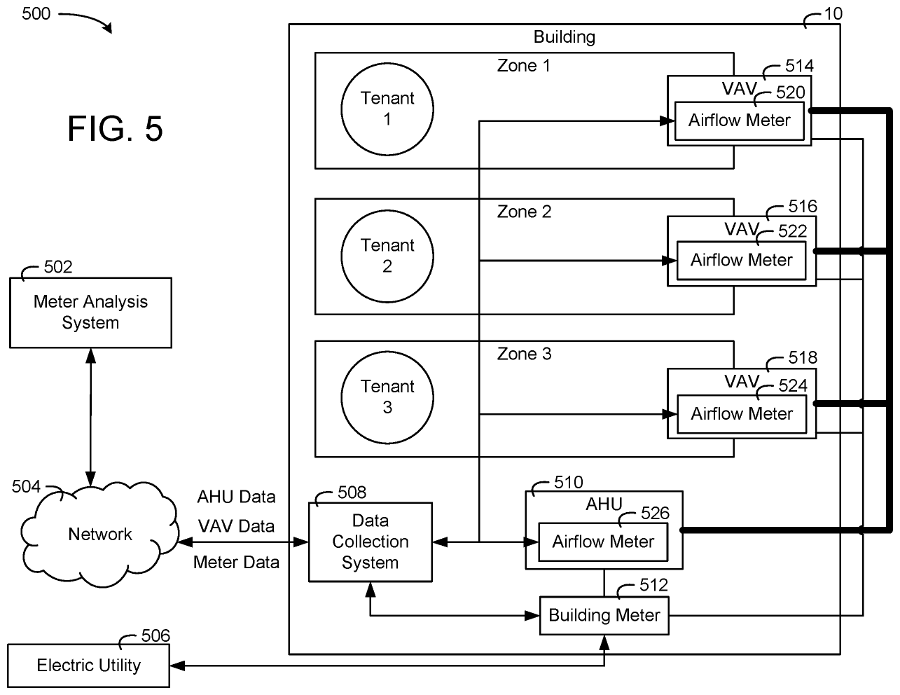

Referring now to FIG. 5, a system 500 is shown including the building 10 of FIG. 1, the building 10 including a single building meter 512, a meter analysis system 502, and multiple zones 1-3 each rented by tenants 1-3 respectively, according to some embodiments. The building 10 is shown to be served by AHU 510 and VAVs 514-518. In some embodiments, the AHU 510 is the same as and/or similar to AHU 106 as described with reference to FIG. 1 and/or AHU 302 as described with reference to FIG. 3. Similarly, VAVs 514-518 may be the same as or similar to VAVs 116 as described with reference to FIG. 1. AHU 510 can cause (e.g., cause via a supply fan) heated or cooled air (e.g., air heated or cooled by the AHU 510) to circulate the building 10 through the zones 1-3 and controlled by the VAVs 514-518.

In some embodiments, the tenants 1-3 are associated with zones 1-3. The tenants 1-3 can be apartment occupants leasing an apartment unit from the building 10, a company renting an area of the building 10 for their company, and/or any other entity that wants to lease any other area, the areas of building 10 represented by the zones 1-3. In some embodiments, a building model stored by a meter analysis system 502 maps the tenants 1-3 to their respective spaces, the zones 1-3. Furthermore, the respective zones 1-3 are mapped to the VAVs 514-518. Since the AHU 510 feeds the VAVs 514-518, the building model may include a mapping between the VAVs 514-518 and the AHU 510.

With the building model, the meter analysis system 502 can be configured to determine the usage of the VAVs 514-518 for each of the tenants 1-3 based on collected airflow data of the VAVs 514-518 and/or the AHU 510. Based on airflow data collected for both the AHU 510 and the VAVs 514-518, the meter analysis system 502 is configured to determine an energy usage amount of energy usage recorded by the building meter 512 for each of the tenants 1-3, in some embodiments.

The building meter 512 is shown to receive power from electric utility 506 and power the VAVs 514-518 and the AHU 510 based on the received power. Furthermore, the power received from the electric utility 506 and recorded by the building meter 512 can also be used to power the building 10 in its entirety, e.g., appliances, computers, and/or any other electricity consuming equipment of the building 10 and the zones 1-3. The building meter 512 may be a sensing device configured to record power, energy, voltage, and/or current with various sensing devices, e.g., voltage meters, current clamps, shunt resistors, etc. The electric utility 506 may be a power plant and/or a power grid configured to generate electrical energy from coal, gas, wind power, and/or sunlight and provide the power to the building 10 through the building meter 512.

The building 10 is shown to include a data collection system 508. The data collection system 508 can be interfaced with the AHU 510, the VAVs 514-518, and/or the building meter 512 via building networks (e.g., wired or wireless networks) of the building and/or direct wiring to the AHU 510, the VAVs 514-518, and/or the building meter 512. The data collection system 508 can include one or multiple communications interfaces (e.g., the same as and/or similar to the BMS interface 409 and/or the communications interface 407) for communicating with and collecting data from the AHU 510, the building meter 512, and/or the VAVs 514-518 and providing the recorded data to the meter analysis system 502. The data collection system 508 may be the same as and/or similar to the BMS controller 366 as described with reference to FIG. 4 and may include a processing circuit (same as and/or similar to the processing circuit 404) to process and communicate the data collected from the building 10 and a memory device (the same as and/or similar to the memory 408 as described with reference to FIG. 4) to store the collected data.

Each of the VAVs 514-518 and the AHU 510 include an airflow meter, airflow meters 520-526. Each of the airflow meters can be configured to periodically measure and/or record airflow values of the VAVs 514-518 and the AHU 510. The airflow data may indicate an amount of air, e.g., velocity, volume, flow rate, etc. being sent into an air duct by the AHU 510 and/or an amount of air being allowed into the zones 1-3 by the VAVs 514-518. For example, the airflow meters 520-526 can be configured to record cubic feet per minute (CFM) and/or liters per second (LPS) for each of the VAVs 514-518 and/or the AHU 510.

The airflow data measured by the airflow meters 520-526 can be collected and logged by the data collection system 508. Furthermore, the meter data indicating energy usage of the building 10 can be collected and logged by the data collection system 508. The data collection system 508 can be configured to communicate the data to a remote system via a network 504. The network 504 may be the same as and/or similar to the network 446 and may be, in some embodiments, the Internet. The remote system may be the meter analysis system 502.

The meter analysis system 502 can be any remote server, collection of servers, computer systems, etc. In some embodiments, the meter analysis system 502 is a software module within a computing program hosted remotely on a server outside the building 10 and/or on-premises within a server of the building 10. The meter analysis system 502 can be configured to receive the AHU data indicating airflow for the AHU 510 at multiple times of multiple days, the VAV data indicating airflow of the VAVs 514-518 at multiple times of multiple days, and meter data indicating energy consumption by the building 10 of electrical energy generated and provided by the electric utility 506. The meter analysis system 502 can analyze the AHU data, the VAV data, and the meter data to generate a bill for each of the tenants 1-3.

The meter analysis system 502 can be configured to determine, based on a building model, which VAVs are linked to which tenants. For example, a particular tenant may have five VAVs in their rented area of the building. In this regard, the meter analysis system 502 can generate a total daily average VAV airflow value by generating daily average airflow values for each of the VAVs for a particular set of days and then summing the daily average airflow values of the five VAVs linked to the tenant. By dividing the total daily average airflow value for the tenant against an average airflow value for an AHU feeding the VAV units, the meter analysis system 502 is configured to determine a meter share percentage for a particular day for the particular tenant. Such a calculation can be determined for multiple days of a billing period for the tenant. Furthermore, the meter analysis system 502 can average the share percentage for each day of the billing period of the user and then multiply the average share percentage against an energy consumption amount recorded by the building meter 512 for the same billing period. This allows the meter analysis system 502 to accurately determine what amount of electrical consumption and electric charges should be attributed to the particular tenant. Such determinations can be determined for each tenant of a building, allowing energy usage of the multiple tenants to be appropriately attributed even when only a single building meter exists for the building.

Based on the energy used by each of the tenants as determined from the airflow and meter data, the meter analysis system 502 can be configured to generate energy usage bills and/or make automatic transactions with user payment information (e.g., bank numbers, credit card information, etc.) in amounts appropriate for the energy usage by the tenant. In some embodiments, the meter analysis system 502 generates and manages a user interface that a user can interact with to view their energy usage and make payments for their rent and/or energy usage. Furthermore, via the same or a similar user interface, a building manager can manage the leases, building model (e.g., mappings between tenants, spaces, VAVs, AHUs, and/or meters) to allow the meter analysis system 502 to determine the energy usage of each tenant and/or generate tenant bills.

In some embodiments, in a single meter-multiple tenant system the single meter needs to be apportioned across the multiple tenants, e.g., in the system 500. The initial apportionment of meter share can be based on historical data of the VAV air flows & AHU airflows serving to specific tenants. After the initial apportionment, the meter share can dynamically change at the end of the billing cycle based on the ratio of daily average flow computations of VAVs & AHU after cleaning out the data, in some embodiments.

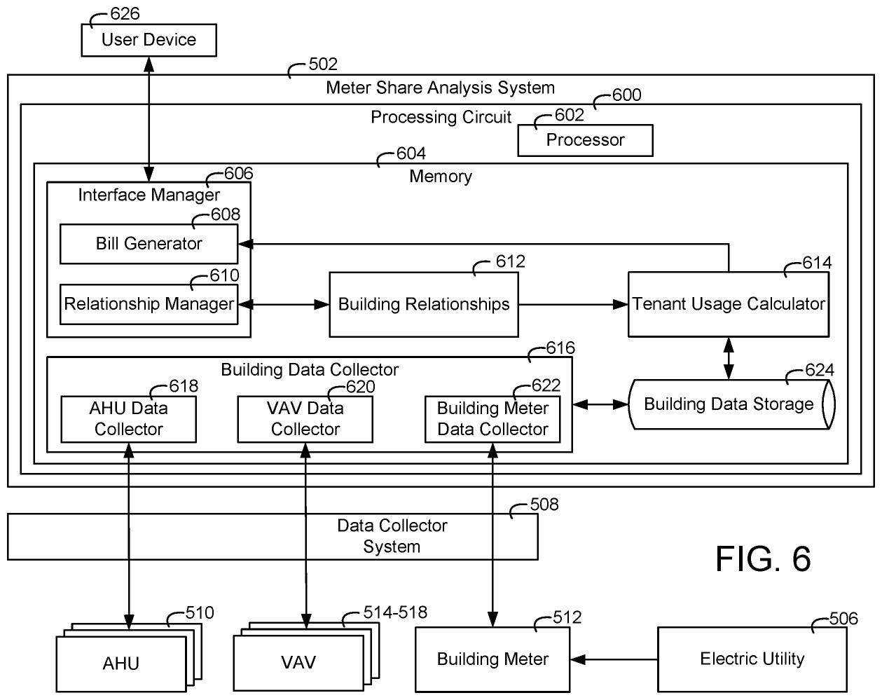

Referring now to FIG. 6, the meter share analysis system 502 is shown in greater detail for determining energy usage of tenants based on airflow data, according to an exemplary embodiment. The meter share analysis system 502 includes a processing circuit 600 in some embodiments. The processing circuit 600 includes a processor 602 and a memory 604 in some embodiments. The processing circuit 600, the processor 602, and/or the memory 604 may be the same as or similar to the processing circuit 404, the processor 406, and/or the memory 408 as described with reference to FIG. 4.

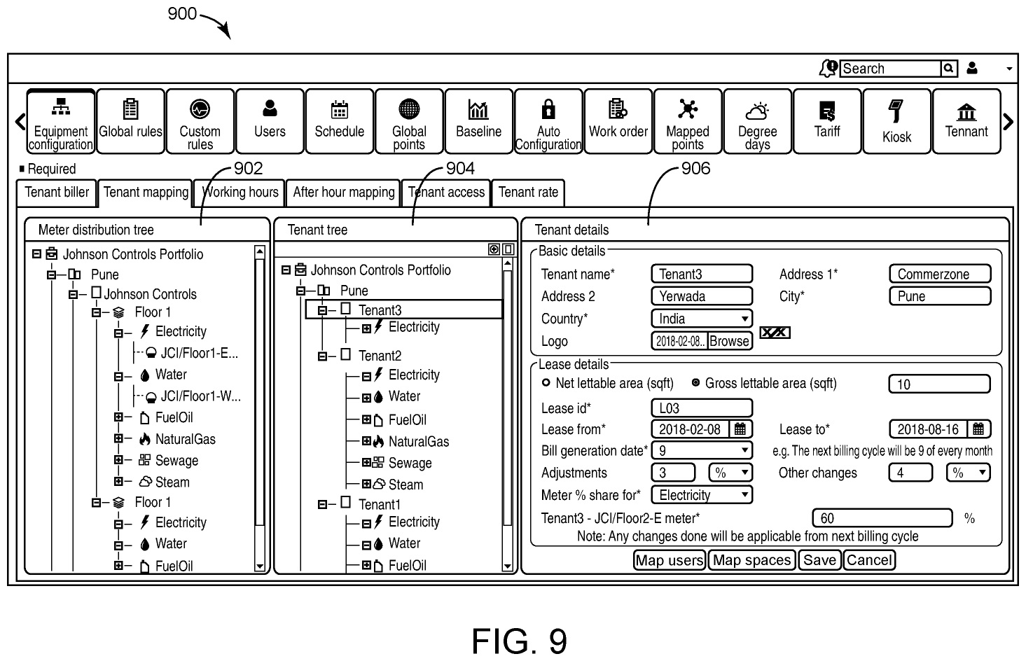

The memory 604 includes an interface manager 606, a building data collector 616, building relationships 612, tenant usage calculator 614, and/or building data storage 624, in some embodiments. The interface manager 606 is configured to generate tenant bills (e.g., based on lease payments and/or utility charges) and provide the tenant bills via a user interface to user device 626. Furthermore, the interface manager 606 can allow a user to review and edit lease details and perform mapping between a tenant, spaces, and/or equipment (e.g., building meters). An example of such a user interface is shown in FIG. 9. User device 626 may be the same as or similar to the client devices 448. In particular, bill generator 608 as included by interface manager 606 can be configured to generate the bills and/or user interfaces including the bills and cause the user device 626 to display the bills.

The memory 604 includes building relationships 612. The building relationships 612 may define a building model mapping various pieces of equipment, spaces, and users together. One example of such a building model is BRICK. Details of BRICK can be found in U.S. Patent Application No. 62/751,926 filed Oct. 29, 2018, the entirety of which is incorporated by reference herein. The building relationships 612 can link tenants to particular zones or other areas which they rent, e.g., the tenant 1 mapped to the zone 1, the tenant 2 mapped to the zone 2, and the tenant 3 mapped to the zone 3. Furthermore, the building relationships 612 may link particular VAVs 514-518 to the zones and areas and by transitive property, to the respective tenants. Finally, the VAVs 514-518 fed by the AHU 510 (which may also be a group of AHUs) can be linked together via the building relationships 612.

The interface manager 606 can generate various tree view based structures representing the entities and relationships of the building relationships 612. An example of such a user interface is shown in FIG. 9. Via the user interface, a user can provide input mapping various meters to tenants, tenants to spaces, meters to VAVs, VAVs to AHUs, etc. The relationship manager 610 can generate and/or manage (e.g., receive user input, update the interface, etc.) the user interface of FIG. 9. Based on input received via the user device 626 and the user interface, the relationship manager 610 can generate and/or update the building relationships 612.

The building data collector 616 can receive AHU data, VAV data, and/or meter data from the AHU 610, the VAV 514-518, and/or the building meter 512 via the data collection system 508. The building data collector 616 may be configured to aggregate, cleanse, and/or generate data for storage in the building data storage 624. The building data collector 616 includes an AHU data collector 618, a VAV data collector 620, and a building meter data collector 622, each configured to record, cleanse, aggregate, and/or store data received from the AHU 510, the VAVs 514-518, and the building meter 512 respectively.

The tenant usage calculator 614 can be configured to generate an appropriate usage amount for each of multiple tenants based on data collected from the AHU 510, the VAVs 514-518, and/or the building meter 512. The tenant usage calculator 614 can be configured to utilize the relationships between tenants and spaces, the AHU 510, the VAVs 514-518, and/or the building meter 512 to generate the tenant usage.

As a part of a setup phase, a building operator can map tenants to the spaces, e.g., map the tenants 1-3 to the zones 1-3 respectively. For example, the relationship manger 610 can generate a user interface (e.g., the user interface shown in FIG. 9) and allow an operator to define the relationships between the tenants and the spaces via the user device 626 and store the relationships as the building relationships 612. Furthermore, the user can map building meters (e.g., the building meter 512) to the tenants and/or equipment associated with spaces of the tenants (e.g., the AHU 510 and/or the VAVs 514-518) and indirectly to the tenants by since the equipment are mapped to the spaces and the spaces are mapped to the tenants. In this regard, the determinations made by the tenant usage calculator 614 can take into account which meters (e.g., the building meter 512), which VAVs 514-518, and/or which AHUs (e.g., the AHU 510) are mapped to the which tenants.

In a case where multiple tenants are mapped to a single meter, the user may enter a meter share percentage manually causing energy usage recorded by the building meter 512 to be divided based on the percentages by the tenant usage calculator 614 and billed to the particular tenant. Furthermore, in cases where the user clicks an automatic/dynamic meter share option presented to the user via the user interface, the tenant usage calculator 614 can instead fetch historical data of the meter (e.g., the building meter 512) associated with multiple tenants and/or airflow data associated with the multiple tenants (e.g., airflow data associated with VAVs and/or AHUs linked to the tenants) to dynamically determine an energy usage by each of the tenants.

The VAV units 514-518 be serve tenant areas (e.g., zones) with hot air or cold air conditioned by the AHU 510. The AHU 510 can be configured to utilize the airflow meter 526 to measure the total air flow supplied by it. Furthermore, each of the VAVs 514-518 measure the maximum flow to the zone the VAVs 514-518 are serving via the airflow meters 520-524, in some embodiments. The tenant usage calculator 614 retrieve a total flow measured by VAVs 514-518 for each zone occupied by the tenants during the occupied hours of the space (e.g., work hours if a tenant is a business). The tenant usage calculator 614 may only retrieve data for the VAVs 514-518 where a common building meter, the building meter 512, is shared between the tenants.

Since initially there should be a meter share value associated with the shared meter with multiple tenants, the tenant usage calculator 614 is configured to retrieve the historical data (based on the billing cycle of each tenant) of the air flow of VAVs associated with each tenant and is configured to determine a daily dynamic meter share percentage for each tenant, in some embodiments. As an example of the determinations performed by the tenant usage calculator 614, the following mappings between tenants 1-3 and VAVs (e.g., VAVS 514-518) can exist.

TABLE 1
Examplary mapping between tenants and VAVs

| Tenant | Number of VAVs |
|---|---|
| Tenant 1 | 2 VAVs |
| Tenant 2 | 12 VAVs |
| Tenant 3 | 15 VAVs |

In some cases, the VAVs mapped between tenants of a shared building meter 512 are VAVs that have air delivered to them by a single AHU or sometimes a group of AHUs collectively. For every occupied hour (e.g., considering 6 AM-5 PM) each VAV's hourly average airflow can be determined by the tenant usage calculator 614 based on data stored and retrieved from the building data storage 624. The average hourly airflow may be in units of cubic feet per minute (CFM) and/or liters per second (LPS). Table 2 below provides an exemplary table of calculators for a single tenant on a single day that can be performed by the tenant usage calculator 614. However, the tenant usage calculator 614 can determine multiple airflows for multiple tenants on multiple days (e.g., across days of a billing period associated with each of the tenants).

TABLE 2
Examplary VAV average hourly airflow calculations
for a particular tenant on a particular day
Tenant 1 - December 1^{st}

| Time | | VAV 1 Airflow (CFM) | VAV 2 Airflow (CFM) |
|---|---|---|---|
| 6:00 | A.M. | 1450 | 1692 |
| 7:00 | A.M. | 1298 | 1198 |
| 8:00 | A.M. | 1123 | 1132 |
| 9:00 | A.M. | 981 | 1781 |
| 10:00 | A.M. | 1186 | 1321 |
| 11:00 | A.M. | 1008 | 1089 |
| 12:00 | P.M. | 1290 | 1428 |
| 1:00 | P.M. | 1002 | 1389 |
| 2:00 | P.M. | 1139 | 1562 |
| 3:00 | P.M. | 1342 | 1433 |
| 4:00 | P.M. | 1002 | 1773 |
| 5:00 | P.M. | 1169 | 1621 |

Furthermore, the airflow created by a supply fan of the AHU 510 supplying to the VAVs 514-518 can also average by the tenant usage calculator 614 for the same occupied duration (e.g., from 6 AM-5 PM) on the same. Again, the flow will be in unit such as CFM and/or LPS and/or can be determined for occupied hours of multiple days of billing periods of the tenants.

TABLE 3
Examplary AHU average hourly airflow calculations
for a AHU on a particular day
AHU 1 - December 1^{st}

| | |
|---|---|
| Time | Airflow (CFM) |

| | | |
|---|---|---|
| 6:00 | A.M. | 32282 |
| 7:00 | A.M. | 30922 |
| 8:00 | A.M. | 29656 |
| 9:00 | A.M. | 31556 |
| 10:00 | A.M. | 28999 |
| 11:00 | A.M. | 31668 |
| 12:00 | P.M. | 28454 |
| 1:00 | P.M. | 27346 |
| 2:00 | P.M. | 34566 |
| 3:00 | P.M. | 36555 |
| 4:00 | P.M. | 32897 |
| 5:00 | P.M. | 34521 |

While taking the average of the VAV flow data for the particular days, the tenant usage calculator 614 can be configured to clean the data by removing any values of zero, any values which are higher than the maximum designed flow of each VAV (e.g., in case of absence of designed flow, the tenant usage calculator 614 automatically calculates the maximum flow based on the historical data), and/or any values which are less than the minimum designed flow of each VAV (e.g., in case of absence of designed flow, the tenant usage calculator 614 is configured to automatically calculate the minimum flow based on the historical data), in some embodiments.

Furthermore, while taking the average of the AHU flow data, the tenant usage calculator 614 is configured to remove any values of zero and/or any values which are higher than the maximum designed flow of each AHU (e.g., in case multiple AHU's are feeding air to multiple VAV's) (e.g., in case of absence of designed flow, the tenant usage calculator 614 is configured to automatically calculate the maximum flow based on the historical data).

In response to determining the hourly average VAV and AHU airflow values, the tenant usage calculator 614 is configured to generate a daily average VAV airflow value for all VAV's for each tenants and sum the daily VAV airflow values for each of the VAVs mapped to a tenant as determined by the tenant usage calculator 614 from the building relationships 612. For example, for tenant 1 mapped to VAV 1, the average flow for December 1^{st} is 1165 CFM. Furthermore, for the tenant 1 mapped to the VAV-2, the average flow for December 1st is 1451 CFM. For tenant 1, the total contribution to total HVAC consumption is the daily average airflows of VAV 1 and VAV 2 summed is 1165+1451=2616. Similarly, total values can be determined by the tenant usage calculator 614 for each tenant and/or can be determined for multiple days of a billing period of each tenant.

Furthermore, for the AHU 1 average, the tenant usage calculator 614 is configured to average the hourly average airflow values to determine a daily average airflow, in some embodiments. For December 1^{st}, by averaging all the hourly average airflow values, the tenant usage calculator 614 can determine a daily average AHU airflow value of 31618 CFM. The tenant usage calculator 614 is configured to determine the daily average AHU airflow value for multiple days, e.g., days of a billing cycle for one or multiple of the tenants, in some embodiments.

Based on the total daily average VAV air flow value for each of the tenants and the daily average AHU air flow for each of the tenants, the tenant usage calculator 614 is configured to determine a daily usage percentage for each tenant, in some embodiments. The daily usage percentage may be determined as,

$$Daily usage percentage = 100 \% * \frac{Total daily average VAV airflow value}{Daily average AHU airflow value}$$

As an exemplary determination, for a particular tenant which a total daily average VAV airflow value of 2616 CFM and a corresponding daily average AHU airflow of 31618 CFM on December 1^{st}, the daily usage percentage for December 1^{st} can be determined for the tenant as 100%*(2616/31618)=8.2%.

As an example, 8.2% is a starting value for meter share for tenant 1. The daily usage percentage can be determined for multiple days of a billing cycle for the tenant 1. Similarly, such determinations can be performed by the tenant usage calculator 614 for each of multiple tenants to arrive at an initial meter share for the other tenants. This way, daily average VAV airflow values, daily total average VAV airflow values, and daily average AHU airflow values for each of the multiple tenants for multiple days of billing cycles of the multiple tenants can be determined by the tenant usage calculator 614 similar to the calculation shown above and based on these values, a daily usage percentage can be determined for each respective tenants.

In some embodiments, the tenant usage calculator 614 checks the billing cycle for each tenant and assigns the average of the daily usage percentages between the days of the billing cycle for the respective tenant. This average usage percentage is then multiplied to the meter consumption for the corresponding days of the billing days of each tenant to arrive at respective meter consumption for each tenant.

As an example, if tenant 1 is associated with a billing cycle at the 15^{th} of every month, tenant 2 is associated with a billing cycle at the 3^{rd} of every month, and tenant 3 is associated with a billing cycle at the 28^{th} of every month, the tenant usage calculator 614 is configured to determine the meter consumption between the 15^{th} to 14^{th} for tenant 1, between the 3^{rd} to 2^{nd} for tenant 2, and/or between the 28^{th} to 27^{th} for tenant 3. The tenant usage calculator 614 is configured to check for the average meter share value for each tenant for the same period which is between the 15^{th} to 14^{th} for tenant 1, between the 3^{rd} to 2^{nd} for tenant 2, and/or between the 28^{th} to 27^{th} for tenant 3. The tenant usage calculator 614 is configured to multiply the average meter share value by the consumption for each tenant for the respective bill cycle to arrive at the consumption for each tenant who share a common meter. In this way instead of relying on a static meter share value to apportion the consumption to multiple tenants using the same meter, the tenant usage calculator 614 is configured to dynamically assign meter sharing based on actual and historical usage for each tenant, in some embodiments.

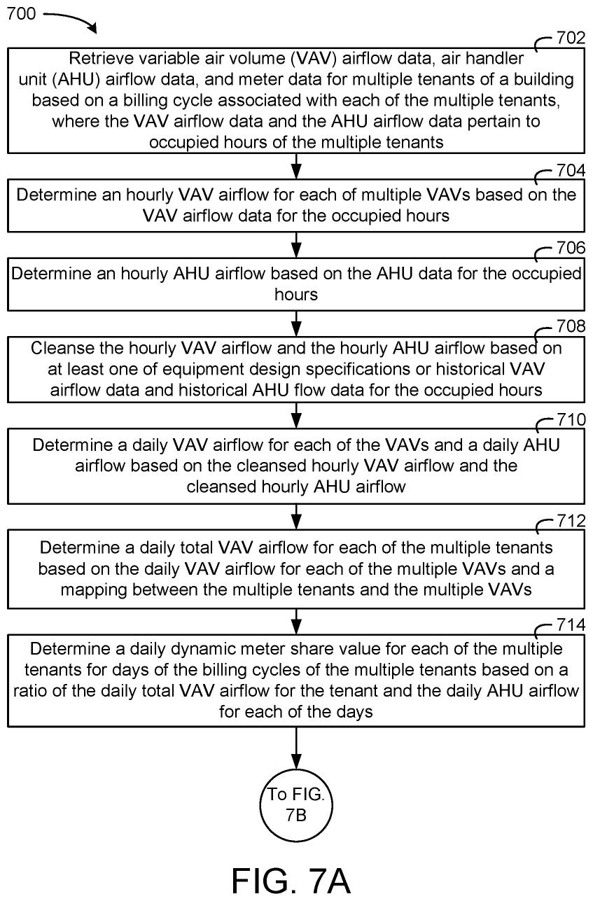

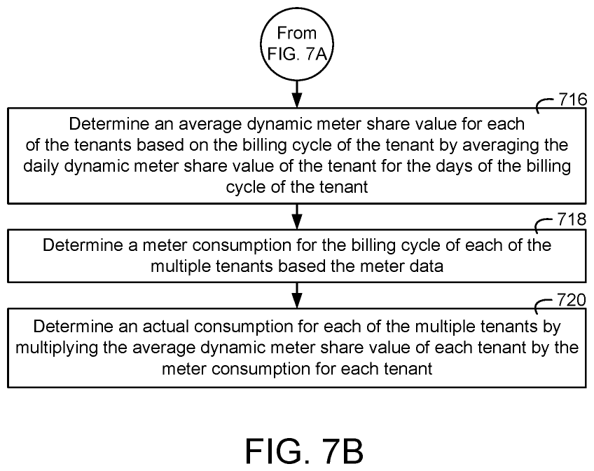

Referring now to FIGS. 7A-7B, a process 700 of determining tenant energy usage for a single building meter based on airflow data of the VAVs and the AHUs that can be performed by the meter analysis system 502 of FIG. 6 is shown, according to an exemplary embodiment. The meter share analysis system 502 is configured to perform the process 700 in some embodiments. Furthermore, any computing device as described herein can be configured to perform the process 700.

Generally, the meter share analysis system 502 can perform the process 700 to determine specific energy usage amounts for particular tenants where the tenants share the building meter 512 by fetching historical VAV flow data for each tenant during occupied hours based on the billing cycle for the tenants from the building data storage 624, cleansing the values for flow based on equipment design specifications and/or historical data for occupied hours, determining a daily dynamic value of meter share based on the ratio of total tenant VAV flow to total AHU flow serving to these VAV's based on tenant billing cycle, determining the meter consumption for each tenant based on each tenant billing cycle, determining the average meter share value from the individual daily dynamic values for each tenant based on each tenant billing cycle, and multiplying the dynamic average meter share value with meter consumption to arrive at actual consumption for each tenant.

In step 702, the tenant usage calculator 614 retrieves VAV airflow data, AHU airflow data, and meter data for the AHU 510, the VAVs 514-516, and the building meter 512 stored in the building data storage 624. In some embodiments, the data is retrieved by the tenant usage calculator 614 is based on billing cycles of multiple tenants. For example, each tenant may be associated with a particular time period. In this regard, the tenant usage calculator 614 queries the building data storage 624 based on the days of the billing cycles of the multiple tenants to retrieve data for current billing cycles and/or billing cycles that are close to completion.

In some embodiments, the tenant usage calculator 614 queries the building data storage 624 based on tenants and a mapping between the tenants and the AHU 510, VAVs 514-518, and the building meter 512. For example, building relationships 612 may indicate that a particular tenant is mapped to the AHU 510, the VAV 514, and the building meter 512. In this regard, the tenant usage calculator 614 queries the building data storage 624 for data collected for an AHU, one or multiple VAVs, and a building meter linked to a particular tenant. Furthermore, the VAV airflow data and the AHU flow data may be retrieved for particular occupied hours. In this regard, only airflow values between a certain period of time (e.g., 9 AM to 5 PM) may be retrieved. The VAV and AHU data can be collected for o occupied periods for various tenants on various days (e.g., days of a billing period).

In step 704, the tenant usage calculator 614 determines an hourly VAV airflow for each of multiple VAVs based on the VAV airflow data for the occupied hours. In some embodiments, the VAV data represents airflow for the VAVs 514-518 at particular intervals, e.g., every second, every minute, etc. In this regard, the tenant usage calculator 614 can average the airflow for each of the VAVs 514-518 for each hour to determine an hourly VAV airflow for each of the occupied hours.

In step 706, the tenant usage calculator 614 determines an hourly AHU airflow the AHU 510 based on the AHU airflow data for the occupied hours. In some embodiments, the AHU airflow data represents airflow for the AHU 510 at particular intervals, e.g., every second, every minute, etc. In this regard, the tenant usage calculator 614 can average the airflow for each hour to determine an hourly AHU airflow for each of the occupied hours.

In step 708, the tenant usage calculator 614 can cleanse the hourly VAV airflow determinations of the step 704 and the hourly AHU airflow determinations of the step 706. The tenant usage calculator 614 can cleanse the data based design specifications of the AHU 510 and/or the VAVs 514-518 and/or based on historical data for the AHU 510 and/or the VAVs 514-518. For example, the tenant usage calculator 614 can remove any value that is zero. Furthermore, the tenant usage calculator 614 can remove any data that is greater than, or less than, a maximum or minimum value for the AHU 510 and/or the VAVs 514-518. The maximum and minimum values may be based on design specifications or other computed from historical data for the AHUs 510 and/or the VAVs 514-518.

In step 710, the tenant usage calculator 614 can determine a daily VAV airflow for each of the VAVs and a daily AHU airflow. For example, the tenant usage calculator 614 can average the hourly VAV airflow values cleansed in the step 708. Since the VAV airflow values cleansed in the step 708 may be for multiple days, the tenant usage calculator 614 can determine a daily VAV airflow for each of the VAVs for the multiple days. Similarly, the tenant usage calculator 614 can average the hourly AHU airflow values cleansed in the step 708 to determine an average AHU airflow value for one or multiple days by averaging the hourly AHU airflow values for each day.

In step 712, the tenant usage calculator 614 can determine a daily total VAV airflow for each of the multiple tenants based on the daily VAV airflows for each of the multiple VAVs and a mapping between the multiple tenants and the multiple VAVs. For example, the tenant usage calculator 614 can determine which tenants are mapped to which VAVs via the building relationships 612. For a tenant where one or multiple VAVs are mapped to a single tenant, the daily total VAV airflow can be the daily VAV airflow when the tenant is mapped to one VAV or a summation of the multiple VAVs when the tenant is mapped to the multiple VAVs. The daily total VAV airflow can be determined for each tenant for one or multiple days.

In step 714, the tenant usage calculator 614 can determine a daily dynamic meter share value for each of the multiple days for days of the billing cycles of the multiple tenants based on a ratio of the daily total VAV airflow for the tenant and the daily AHU airflow for each of the days. The daily dynamic meter share value can be determined for a single day for a particular tenant by dividing the total VAV airflow for the particular tenant for the single day by the daily AHU airflow for the single day. The daily dynamic meter share value can be determined for each of the tenants and for multiple days, e.g., for the days of the billing cycle of each of the tenants.

In step 716, the tenant usage calculator 614 can determine an average dynamic meter share value for each of the tenants based on the billing cycle of the tenant by averaging the daily dynamic meter share value of the tenant for the days of the billing cycle of the tenant. In step 718, the tenant usage calculator 614 can determine a meter consumption for the billing cycle of each of the multiple tenants based on the meter data. In some embodiments, the tenant usage calculator 614 uses the meter data to determine a total amount of power consumed across each billing cycle of all of the billings cycles of the tenants based on the meter data collected by the building meter 512. In step 720, the tenant usage calculator 614 can determine an actual consumption for each of the multiple tenants by multiplying the average dynamic meter share value of each tenant by the meter consumption for each tenant.

Referring generally to FIG. 5 and FIGS. 8-9, the meter share analysis system 502 provides an automatic mechanism of causing a tenant to become a part of navigation tree by mapping the tenant to a space, according to various exemplary embodiments. The mechanism may be and/or may be implemented by the relationship manager 610 of the meter share analysis system 502 as described with reference to FIG. 6. A tenant billing system, e.g., the tenant billing system implemented by the meter share analysis system 502, is configured to capture the tenant energy utilization data directly from the corresponding meters (e.g., the building meter 512) using the building management system, in some embodiments. The system is configured to generate bills automatically based on the charges defined, in some embodiments. The meter share analysis system 502 also maintains the lease details and other property related information and includes the monthly rentals and other charges automatically in the bills.

The interface manager 606 of the meter share analysis system 502 can implement a portal for the user device 626 so that a user can track energy spend and consumption, benchmarking and make online after-hour consumption requests (e.g., making a request to expand occupancy hours to cause the meter share analysis system 502 to cause VAVs and/or AHUs to condition a building space). In order to perform these operations, a large amount of data and configuration steps may be required. For example, the configuration steps may include integrating meters into an enterprise system and configuring meters by defining the meter type, commodities, load types, etc. The configuration steps may include creating tenants along with a tenant property related information, e.g., lease details. The configuration steps may include mapping meters to tenant with their share percentages and mapping of users with tenants, and mapping spaces with the tenants. Some and/or all of these configuration steps can be implemented by the interface manger 606 via a user interface interacted with by the user device 626.

For the meter share analysis system 502 to achieve good results it may be important that the configuration of the meters, spaces, equipment, and/or tenants is performed accurately. Since a large number of steps are involved, the configuration process, manual configuration can lead to user mistakes. The relationship manager 610 can solve the above problem by providing the user with guidance and can help customer to achieve the desired outcomes accurately and reduce configuration time. The relationship manager 610 allows a user to spend less time in configuration of points and there are less chances of mistakes being made. The relationship manager 610 can perform a configuration which does not solely rely on the user and improves the accuracy for the data mapped but rather aids the user in the configuration. The relationship manager 610 can ensure that mistakes are eliminated and configuration reworks are less frequent, hence reducing overall configuration time. This may lead to better product adaptability for customers.

The relationship manager 610 is configured, in some embodiments, to implement an automatic algorithm in the sharing percentage of the meters between different tenants. The relationship manager 610 includes a validation ensures that the percentage share of meters does not exceed, or fall below, one hundred percent. If the lease date expires for a particular tenant, the interface manager 606 can prevent the tenant from logging in to a tenant portal via the user device 626, the tenant portal managed by the interface manager 606. Also, the relationship manager 610 is configured to cause the percentage share for the meters mapped to automatically become free and the meter share is allowed to be used for another tenant when a lease of a tenant expires, in some embodiments.

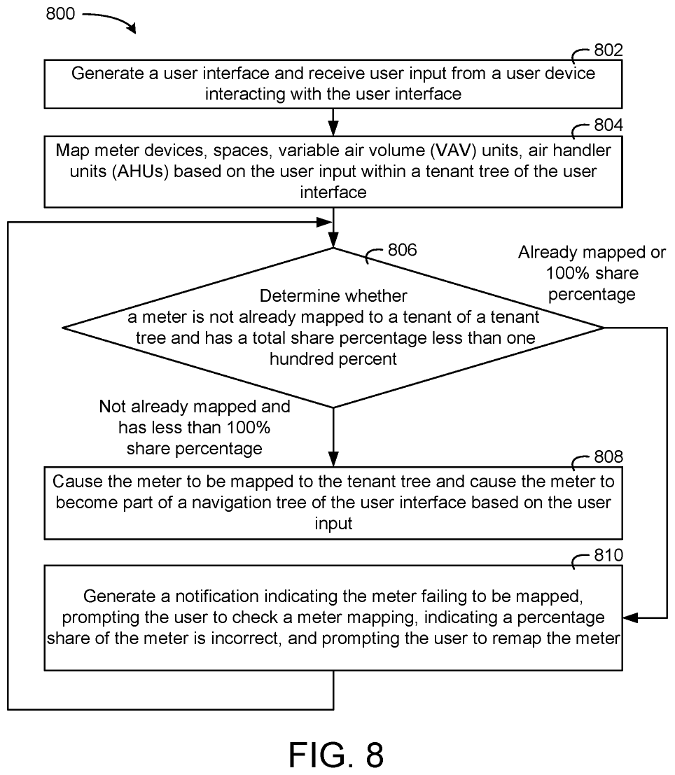

Referring now to FIG. 8, a process 800 of operating a user interface to map an energy meter to a component tree is shown, according to an exemplary embodiment. In some embodiments, the meter share analysis system 502 is configured to perform the process 800. More particularly, the relationship manager 610 is configured to perform the process 800 in some embodiments. Furthermore, any computing device as described herein can be configured to perform the process 800.

In step 802, the relationship manager 610 can generate a user interface, cause the user device 626 to display the user interface, and receive user input from the user device 626. The user interface may be a tenant configuration screen, e.g., the user interface of FIG. 9. In some embodiments, the user interactions include the user mapping building meters to other entities (e.g., tenants) of a tenant tree illustrating various building elements and their relationships between each other. In step 804, the relationship manager 610 can map meter devices, spaces, VAVs, AHUs together based on the step 802. The tenant tree can include the various entities and the user can define the various relationships between the entities, the tenant tree may be the same as or similar to the tenant tree 904 as described with reference to FIG. 9.

In step 806, the relationship manager 610 can determine whether a meter is not already mapped to a tenant of a tenant tree (e.g., the tenant tree 904) and has a total share percentage less than one hundred percent. These conditions may be present while a user is interacting with the elements of the interface, e.g., in step 802, causing the interface to map a particular meter to a particular tenant. If both of these conditions are true, the process 800 proceeds to step 808 allowing the user to map the meter to a particular tenant without providing the notification of the step 810.

If either of the conditions are not true, the process 800 proceeds to step 810. In this regard, if a building meter is already mapped to a tenant or tenants and the user attempts to map the meter to another user, the notification of the step 810 can be displayed to the user. Furthermore, if the user defines static share percentages to add up to 100 percent and then attempts to map the meter to another tenant, the process 800 performs the step 810 to display the notification to indicate to the user that they may be misconfiguring the meter and prompting the user in properly configuring the meter share analysis system 502.

In step 808, the relationship manager 610 can cause the meter to be mapped to the tenant tree and causes the meter to become part of a navigation tree of building elements of the user interface based on the user input of the step 802. For example, based on user input, e.g., the user input of the step 802, the relationship manager 610 can cause the meter to be added to the tenant tree 804. In step 810, the relationship manager 610 can generate a notification of the meter failing to be mapped properly. The notification may prompt the user to check a meter mapping or indicate to a user that a percentage share of the meter is incorrect. The notification can prompt the user to remap the meter. The notification can be displayed as a window overlaying part of the interface 900.

Referring now to FIG. 9, a user interface 900 that the meter analysis system of FIG. 6 can generate and manage is shown, according to an exemplary embodiment. The user interface 900 may be a setup page for a tenant of an enterprise system where meter points from a Building Automation System point tree (meter distribution tree 902) are mapped to the tenant tree 904 on the right by incorporating the automatic mechanism for mapping data as described in the process 800. This enables the meter and its points, the commodity type, tenant, the space occupied by tenant and the users to be a part of the navigation tree with minimum configuration steps.

The meter distribution tree 902 includes meter details configured in a meter configuration tab (not shown in FIG. 9) which allows a user to input information of the commodity type, the load types, points details, etc. of the meter. A center tree (not shown in FIG. 9) can provide a user with the option to create the tenant tree 904 with all the tenant related information to be entered which is utilized in the billing and a tenant portal.

All the above information is then merged by the user interface 900 allow a user to drag and drop the meters to the associated tenants, e.g., drag meters from the meter distribution tree 902 to the tenants of the tenant tree 904. The user interface 900 can provide a mechanism of setting up online after-hours requests just by mapping the request to the tenant tree 904 which also becomes part of the meter distribution tree 902.

The meter distribution tree 902 include space and meter nodes. The space tree will appear based on the space access provided at a setup step where users and roles are configured and at a rights step where users are mapped to spaces. Meters can be dragged and dropped to a tenant in the tenant tree 904 from the meter distribution tree 902 to assign the meter to the tenant.

The tenant tree 904 appears with a portfolio and location node (e.g., the portfolio of a particular company the a location, e.g., building, where the tenants rent) based on space tree access given to the role of the user logged in during a registration phase of the user. The tenant tree 904 is one interface location where tenant can be added under a location level by selecting the location (e.g., Pune) and clicking the plus icon (e.g., the plus icon in the top right of the tenant tree 904 window). In this example, a user will highlight the location “Pune” and click on plus icon to add a tenant called “Tenant 3” under that.

For each tenant created, information for the tenant can be filled on the right panel, tenant details 906. The meters will appear under the tenant node under the location level (e.g., the tree should also show the parent nodes of commodity like electricity, Gas etc.) A meter is mapped to a tenant by dragging and/or dropping the meter from the meter distribution tree 902 to a tenant of the tenant tree 904. The interface 900 can allow the same meter to be mapped to multiple tenants. Multiple meters from different commodities can be mapped under each tenant. The name of the meter under a tenant can be in the format of Building name_Meter name. On hovering on the meter the interface 900 may show information (e.g., a breadcrumb) of the meter i.e., in the above example for Company X HQ_SDB1 Meter 3 Total, on hover a tooltip should appears as: Company X Corporate/Dublin Ireland/Company X HQ/Floor 3/Electricity/SDB1 Meter 3 Total. For each meter mapped to a tenant, the tenant details may show the meter in the meter percentage share section of the tenant details 906.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building system of a building, the building system comprising one or more memory devices configured to store instructions that, when executed by one or more processors, cause the one or more processors to:
receive meter data from a meter of the building, the meter data indicating energy usage of a plurality of tenants of the building collectively;
receive variable air volume (VAV) airflow data of a plurality of VAV units indicating environmental conditioning of a plurality of tenant areas associated with the plurality of tenants; and
determine the energy usage of each of the plurality of tenants individually based on the meter data and the VAV airflow data.

2. The building system of claim 1, wherein the instructions cause the one or more processors to generate an energy bill for each of the plurality of tenants based on the energy usage of each of the plurality of tenants and cause a user interface to display the energy bill of at least one of the plurality of tenants.

3. The building system of claim 1, wherein the instructions cause the one or more processors to determine the energy usage of each of the plurality of tenants individually based on the meter data and the VAV airflow data by:
determining, for each of the plurality of tenants, one or more of the plurality of VAV units mapped to the tenant based on a building model; and
determining the energy usage for each of the plurality of tenants on the meter data and the VAV airflow data of the one or more of the plurality of VAV units mapped to the tenant.

4. The building system of claim 3, wherein the building model comprises a plurality of relationships mapping the plurality of tenants with the plurality of tenant areas, wherein the building model further comprises a plurality of relationships mapping the plurality of VAV units with the plurality of tenant areas.

5. The building system of claim 4, wherein determining, for each of the plurality of tenants, the one or more of the plurality VAV units mapped to the tenant based on the building model comprises identifying, based on the building model, the one or more of the plurality of VAV units mapped to one of the plurality of tenant areas that the tenant is mapped to.

6. The building system of claim 1, wherein the instructions cause the one or more processors to:
receive air handler unit (AHU) airflow data, the AHU airflow data further indicating the conditioning of the plurality of tenant areas;
determine an energy usage percentage for each of the plurality of tenants based on the AHU airflow data and the VAV airflow data; and
determine the energy usage of each of the plurality of tenants individually based on the meter data and the energy usage percentage for each of the plurality of tenants.

7. The building system of claim 6, wherein the instructions cause the one or more processors to determine the energy usage percentage for each of the plurality of tenants based on the AHU airflow data and the VAV airflow data by:
determining an average VAV airflow amount of the tenant based on the VAV airflow data;
determining an average AHU airflow amount based on the AHU airflow data; and
dividing the average VAV airflow amount of the tenant by the average AHU airflow amount to determine the energy usage percentage of the tenant.

8. The building system of claim 7, wherein the average VAV airflow amount of the tenant is a daily average VAV airflow amount, the average AHU airflow amount is a daily average AHU airflow amount, and the energy usage percentage of the tenant is a daily energy usage percentage.

9. The building system of claim 8, wherein the instructions cause the one or more processors to determine the daily average VAV airflow amount of each of the plurality tenants for each of a plurality of days, determine the daily average AHU airflow amount for each of the plurality of days, and determine the daily energy usage percentage of each of the plurality of tenants for each of the plurality of days based on the daily average VAV airflow amount for each of the plurality of days and the daily average AHU airflow amount for each of the plurality of days.

10. The building system of claim 9, wherein the instructions cause the one or more processors to:
determine a metered energy amount based on the meter data across the plurality of days;
average the daily energy usage percentage of each of the plurality of tenants across the plurality of days; and
determine the energy usage of each of the plurality of tenants based on the metered energy amount across the plurality of days and the daily energy usage percentage of each of the plurality of tenants averaged across the plurality of days.

11. The building system of claim 9, wherein the plurality of days are days of a billing cycle associated with the plurality of tenants.

12. A building system of a building, the building system comprising:
an air handler unit (AHU) configured to supply air to a plurality of variable air volume (VAV) units;
the plurality of VAV units configured to supply the air of the AHU to a plurality of tenant areas; and
one or more memory devices configured to store instructions that, when executed by one or more processors, cause the one or more processors to:
receive meter data from a meter of the building, the meter data indicating energy usage of a plurality of tenants of the building collectively;
receive VAV airflow data of the plurality of VAV units indicating environmental conditioning of a plurality of tenant areas associated with the plurality of tenants; and
determine the energy usage of each of the plurality of tenants individually based on the meter data and the VAV airflow data.

13. The building system of claim 12, wherein the instructions cause the one or more processors to generate an energy bill for each of the plurality of tenants based on the energy usage of each of the plurality of tenants and cause a user interface to display the energy bill of at least one of the plurality of tenants.

14. The building system of claim 12, wherein the instructions cause the one or more processors to determine the energy usage of each of the plurality of tenants individually based on the meter data and the VAV airflow data by:
determining, for each of the plurality of tenants, one or more of the plurality of VAV units mapped to the tenant based on a building model; and
determining the energy usage for each of the plurality of tenants on the meter data and the VAV airflow data of the one or more of the plurality of VAV units mapped to the tenant.

15. The building system of claim 12, wherein the instructions cause the one or more processors to:
receive AHU airflow data, the AHU airflow data further indicating the conditioning of the plurality of tenant areas;
determine an energy usage percentage for each of the plurality of tenants based on the AHU airflow data and the VAV airflow data; and
determine the energy usage of each of the plurality of tenants individually based on the meter data and the energy usage percentage for each of the plurality of tenants.

16. The building system of claim 15, wherein the instructions cause the one or more processors to determine the energy usage percentage for each of the plurality of tenants based on the AHU airflow data and the VAV airflow data by:
determining an average VAV airflow amount of the tenant based on the VAV airflow data;
determining an average AHU airflow amount based on the AHU airflow data; and
dividing the average VAV airflow amount of the tenant by the average AHU airflow amount to determine the energy usage percentage of the tenant.

17. The building system of claim 16, wherein the average VAV airflow amount of the tenant is a daily average VAV airflow amount, the average AHU airflow amount is a daily average AHU airflow amount, and the energy usage percentage of the tenant is a daily energy usage percentage.

18. The building system of claim 17, wherein the instructions cause the one or more processors to determine the daily average VAV airflow amount of each of the plurality of tenants for each of a plurality of days, determine the daily average AHU airflow amount for each of the plurality of days, and determine the daily energy usage percentage of each of the plurality of tenants for each of the plurality of days based on the daily average VAV airflow amount for each of the plurality of days and the daily average AHU airflow amount for each of the plurality of days.

19. The building system of claim 18, wherein the instructions cause the one or more processors to:
determine a metered energy amount based on the meter data across the plurality of days;
average the daily energy usage percentage of each of the plurality of tenants across the plurality of days; and
determine the energy usage of each of the plurality of tenants individually based on the metered energy amount across the plurality of days and the daily energy usage percentage of the each of the plurality of tenants averaged across the plurality of days.

20. A method of a building system of a building, the method comprising:
receiving, by a processing circuit, meter data from a meter of the building, the meter data indicating energy usage of a plurality of tenants of the building collectively;
receiving, by the processing circuit, variable air volume (VAV) airflow data of a plurality of VAV units indicating environmental conditioning of a plurality of tenant areas associated with the plurality of tenants;
receiving, by the processing circuit, air handler unit (AHU) airflow data of an AHU further indicating the environmental conditioning of the plurality of tenant areas associated with the plurality of tenants; and
determining, by the processing circuit, the energy usage of each of the plurality of tenants individually based on the meter data, the VAV airflow data, and the AHU airflow data.
